(19) United States
(12) Patent Application Publication
(10) Pub. No.: US 2015/0058187 A1
(43) Pub. Date: Feb. 26, 2015

(54) Mileage Tax Estimation Using Payment Network Data

(71) Applicant: Justin Xavier Howe, Larchmont, NY (US)

(72) Inventor: Justin Xavier Howe, Larchmont, NY (US)

(73) Assignee: MasterCard International Incorporated, Purchase, NY (US)

(21) Appl. No.: 13/974,840

(22) Filed: Aug. 23, 2013

(51) Int. Cl. G06Q 40/00; G06Q 30/02

(52) U.S. Cl. CPC G06Q 40/123; G06Q 30/0284
USPC 705/31

(57) ABSTRACT

A method and system of determining a vehicle mileage tax associated with a consumer includes retrieving data associated with a plurality of transactions associated with a payment account of a consumer, the data including a merchant identifier, a location, and a date and time associated with each of the plurality of transactions. A total mileage traveled by a vehicle associated with the consumer is estimated based on the location, and the date and time associated with the plurality of transactions. A vehicle mileage tax is calculated based on the total mileage estimated for the vehicle associated with the consumer. Additional geotemporal information is provided by mobile devices linked to the payment account and is used to adjust the vehicle mileage estimated from payment transaction geotemporal data.

### FIELD OF THE DISCLOSURE

The present disclosure relates to vehicle mileage tax determination, in particular, to a method and system for estimating vehicle mileage tax of a consumer based on electronic payment transaction data.

### BACKGROUND

Systems currently being considered for estimating a vehicle mileage traveled (VMT) tax require first that all vehicles be equipped with global satellite technology (“GPS”), a transponder for transmitting collected mileage data, and a clock and other equipment needed to record the mileage a vehicle has traveled. Such systems will require sufficient start-up time before any one of them could be implemented on a broad scale. In addition, each requires at least some measure of intrusion on the consumer automobile industry as well as added expenses that will no doubt be passed on to the consumer.

There is an existing need, therefore, for a system and method of vehicle mileage traveled tax estimation and collection.

### SUMMARY

The present disclosure provides a method and system of determining a vehicle mileage tax associated with a consumer. The present disclosure further provides a method and system of collecting the vehicle mileage tax.

In one aspect, the method includes retrieving, by a processing device, data associated with a plurality of transactions associated with a payment account of a consumer. The data includes a merchant identifier, a location, and a date and time associated with each of the plurality of transactions. The method further includes estimating, by the processing device, a total mileage traveled by a vehicle associated with the consumer based on the location, and the date and time associated with the plurality of transactions; and calculating, by the processing device, a vehicle mileage tax based on the total mileage estimated for the vehicle associated with the consumer.

In an additional aspect, the method further includes calculating, by the processing device, a first distance between a pair of sequential locations associated with a time-sequential pair of the plurality of transactions, wherein the estimating the total mileage includes summing a plurality of distances associated with the consumer. The plurality of distances including the first distance.

In another aspect, the plurality of transactions occur within a predetermined period of time, the method further including determining a total route distance corresponding to the plurality of transactions, wherein the total route distance is based on each distance between each pair of sequential locations associated with the plurality of transactions, wherein the total mileage includes the total route distance.

In still another aspect, the method further includes determining the vehicle mileage tax accrued at a point of sale location, the vehicle mileage tax accrued being associated with the payment account of a payment instrument presented by the consumer at the point of sale location. The vehicle mileage tax accrued is included on a bill of sale for payment by the consumer at the point of sale location.

In yet another aspect, the method further includes linking, by the processing device, a mobile device associated with the consumer to the payment account, and recording, by the processing device, geotemporal data comprising location, date and time data associated with the mobile device, wherein the estimating the total mileage traveled by the vehicle is additionally based on the geotemporal data of the mobile device associated with the consumer.

In one aspect, the mobile device is a cell phone.

Both the plurality of transactions and the geotemporal ping data associated with the mobile device preferably occur within a predetermined period of time.

In additional aspects, the method includes generating a list of consumers who purchase tickets as users of mass transit, and adjusting the total route distance associated with the consumer for determining the vehicle mileage tax in response to identifying the consumer as one of the users of mass transit.

A system to determine a vehicle mileage tax associated with a consumer is also provided. In one aspect, the system includes a processing device; and a computer-readable storage medium storing instructions that, when executed by the processing device, cause the processing device to determine a vehicle mileage tax associated with a consumer by performing a computer process that includes retrieving data associated with a plurality of transactions associated with a payment account of a consumer. The data includes a merchant identifier, a location, and a date and time associated with each of the plurality of transactions. The computer process further includes estimating a total mileage traveled by a vehicle associated with the consumer based on the location, and the date and time associated with the plurality of transactions; and calculating a vehicle mileage tax based on the total mileage estimated for the vehicle associated with the consumer

In addition to the above aspects of the present disclosure, additional aspects, objects, features and advantages will be apparent from the embodiments presented in the following description and in connection with the accompanying drawings.

### BRIEF DESCRIPTION OF THE DRAWINGS

FIG. 1 is a schematic illustration of a representative cycle for electronic cashless sales transaction processing.

FIG. 2 is a flow diagram representation of an embodiment of a method of the present disclosure for determining a vehicle mileage tax associated with a consumer who is associated with a payment account within a payment network.

FIG. 3 is a flow diagram representation of an embodiment of a method for collection of the vehicle mileage tax determined in accordance with the method of FIG. 2.

FIG. 4 is a schematic representation of an embodiment of a system for implementing various embodiments of the methods of the present disclosure.

### DETAILED DESCRIPTION OF THE EMBODIMENTS

The following sections describe particular embodiments. It should be apparent to those skilled in the art that the described embodiments provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present method and system as defined herein and equivalents thereto.

Throughout the description, where items are described as having, including, or comprising one or more specific components, or where methods are described as having, including, or comprising one or more specific steps, it is contemplated that, additionally, there are items of the present disclosure that consist essentially of or consist of, the one or more recited components, and that there are methods according to the present disclosure that consist essentially of, or consist of, the one or more recited processing steps.

It should also be understood that the order of steps or order for performing certain actions is immaterial, as long as the method remains operable. Moreover, two or more steps or actions may be conducted simultaneously.

Payment devices which can be issued or authorized for use in an electronic payment network of the present disclosure include, but are not limited to, a payment card, such as a credit or debit card, contactless RFID-enabled devices, including smart cards, NFC-enabled smartphones, electronic mobile wallets and the like as known in the art.

As will be appreciated by those of ordinary skill in the art, payment networks receive transaction data from millions of merchants worldwide. Such transaction data is stored in a central database associated with the payment network, and include detailed payment transaction records. In particular, a payment transaction record is generated whenever any type of cashless payment device is used by a consumer in a payment network. Each transaction record includes at least a consumer account identifier, a merchant identifier, and a location, date and time of the transaction.

A “geotemporal fingerprint” is compiled from a series of geolocations and timestamps that describe a person's travels and activities over a period of time, as further described herein.

The term “geolocation” as used herein refers to a user's location as collected from a cell phone tower or beacon, GPS, RFID, WiFi, Bluetooth or other sources of position indicators, and can include GPS coordinates, street address, an IP address, geo-stamps on digital photographs, smartphone check-in or other data, and other location data provided as a result, for example, of a telecommunications or on-line activity of a user.

“Geotemporal” data is temporal and geolocation data (cell phone tower location, IP address, GPS coordinates) that is sent, usually along with other information, from a communications device a user is accessing (such as, a cell phone tower, computer, GPS device, and so on) to perform a certain activity at a particular time.

The present disclosure is directed to a system and method of estimating a vehicle mileage tax associated with a consumer who participates in a payment network based on data retrieved from the consumer's payment transaction history. The present disclosure further provides a method and system of collecting the vehicle mileage tax.

Each of the previously proposed systems for determining a vehicle mileage tax require implementation of a GPS tracker linked to each consumer's vehicle. While this is the most straightforward means of determining the miles traveled by the vehicle, there are inherent disadvantages, including the time and expense involved in properly outfitting every automobile with an appropriate GPS tracker.

The system of the present disclosure provides a cost-effective and practical alternative, which can be implemented on a broad scale in significantly less time. In particular, the system and method of the present disclosure exploit the existing widespread use by consumers of electronic payment networks, which already record and save payment transaction data associated with consumers' travels and fuel expenditure, to estimate vehicle mileage. Such payment transaction data include a date, time, and location associated with each consumer's cashless transactions.

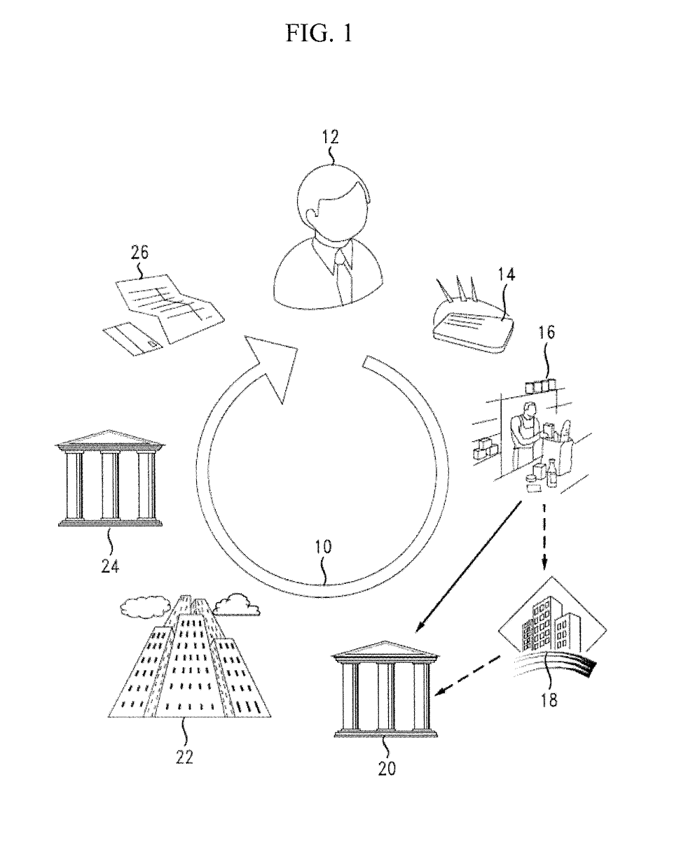

By way of background, referring to FIG. 1, in a typical electronic sales transaction with a merchant, a consumer who has an appropriate payment device, referred to here as a device holder 12, presents a payment device 14 to a merchant 16 as payment for goods and/or services. The payment device 14 can be, for example, any payment card, a credit card, a debit card, an ATM card, a CHIP card, an electronic wallet, a PIN transaction, a transponder device, and/or an NFC-enabled smart phone, among others and without limitation. For simplicity, the payment device 14 is depicted as a type of payment card, although those skilled in the art will appreciate the present disclosure is equally applicable to any cashless payment device, for example, as described above.

In cases when the merchant 16 has an established merchant account with an acquiring financial institution (also called the acquirer) 20, the merchant 16 communicates with the acquirer 20 to secure approval and payment of the transaction. An acquirer 20 is a party or entity, typically a financial institution, which is authorized by the network operator 22 to acquire network transactions on behalf of customers of the acquirer 20 (e.g., merchant 16). Occasionally, the merchant 16 does not have an established merchant account with an acquirer 20, but may secure payment on a transaction through a third-party payment provider 18. The third party payment provider 18 does have a merchant account with the acquirer 20, and is further authorized by the acquirer 20 and the network operator 22 to acquire payments on network transactions on behalf of sub-merchants. In this way, the merchant 16 can be authorized and able to accept the payment device 14 from the device holder 12, without having a merchant account with the acquirer 20.

The acquirer 20 typically routes the transaction request from the merchant to a network operating system (also referred to as “network operator”) 22 controlled by the network operations entity (for example, the network system operated by MasterCard International Incorporated, the assignee of the present disclosure). The data included in the transaction request identifies details, such as, at least, the device holder's payment account identifier, as well as and other information about the instrument used to complete the transaction, amount of sales transaction, a merchant identifier, the geolocation where the transaction occurs, the date and time of the transaction, and other related information. With this information, the network operator 22 routes the transaction to an issuer 24, typically a financial institution, which is authorized by the network operator 22 to issue or authorize payment devices 14 (payment cards in this example) on behalf of its customers (e.g., device holder 12), for use in payment transactions within the payment network. The issuer 24 also typically funds the transaction that it approves. The issuer 24 may approve or authorize the transaction request based on criteria such as a device holder's credit limit, account balance, or in certain instances more detailed and particularized criteria including transaction amount, merchant classification and so on.

The issuer's 24 decision to authorize or decline the transaction is routed through the network operator 22 and acquirer 20, and ultimately to the merchant 16. This entire process is carried out by electronic communication, and under routine circumstances (i.e., valid device, adequate funds, etc.) can be completed in a matter of seconds. It permits the merchant 16 to engage in transactions with a device holder 12, and the device holder 12 to partake of the benefits of cashless electronic payment, while the merchant 16 can be assured that payment is secured.

As a part of this electronic transaction process, a transaction record containing details of the transaction request, including the consumer's (device holder) payment account identifier and other information about the instrument used to complete the transaction, the geolocation, date and time of the transaction, is transmitted and stored in a central database associated with the payment network. Accordingly, transaction records associated with a payment account are regularly generated and recorded with details of the location, date, and time the payment account holder makes a purchase.

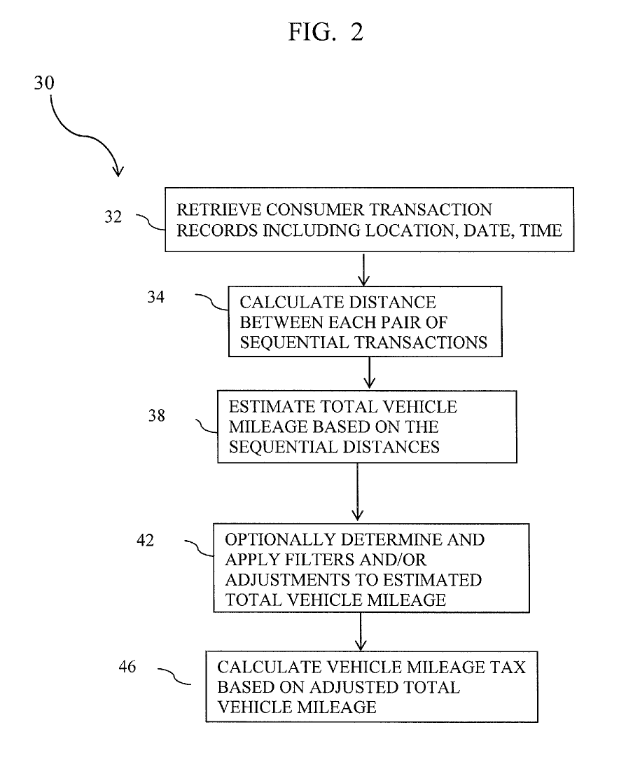

Referring to FIG. 2, in one embodiment of a method of the present disclosure 30, a payment account associated with a consumer is linked to a vehicle, for example, either through an opt-in registration process or by other methods known in the art. The method includes retrieving transaction records 32 containing data associated with a plurality of transactions associated with a payment account of a consumer. The data include a merchant identifier, a geolocation, and a date and time associated with each of the plurality of transactions.

The data may be retrieved from a plurality of sources, including different merchants, toll authorities, ATM machines, and so on. Accordingly, the plurality of transactions retrieved for each consumer are preferably aggregated and may, optionally, be tabulated in a time-sequential order.

The method preferably further includes calculating a distance between each pair of sequential locations 34 associated with each time-sequential pair of the plurality of transactions and estimating a total vehicle mileage based on the distances between the locations associated with the sequential transactions 38. For example, an estimated total mileage can be calculated by summing the distances between each of the sequential locations associated with the transactions.

The method further includes calculating a vehicle mileage tax based on the estimated total mileage 46.

In some instances, the geolocation data will not all be in the same format, such as a merchant street address, but some may be in the form of, for example, GPS coordinates or a source IP address associated with the purchase. In such cases, the geolocation data is preferably converted to a common format from which approximations of the distance between the locations of sequential purchases can be made. Such conversions are well-known by those of ordinary skill in the art.

In additional embodiments, different adjustments and/or filters can be made to the estimated vehicle mileage 42 based on additional sources of location data associated with the consumer.

For example, most consumers also carry with them some type of mobile device, which may be the same device as is used for the electronic transaction, or another device, such as, but without limitation, a cell phone, which may be a smart phone, a tablet, a laptop, a personal digital assistant, a personal digital assistant, or any other computing device and/or mobile device capable of transmitting and/or broadcasting the consumer's geolocation, date, and time. During, before, and/or after an electronic cashless transaction is processed, therefore, additional information about the consumer's location and distances traveled may be obtained from any of these additional mobile devices.

In various embodiments, a consumer's mobile device is equipped with a GPS tracker and a consumer opts-in to transmit geolocation, date and time information, for example, while using apps such as check-in apps, sending an SMS requesting consent, answering a telephone call requesting consent, registering with a local node, and so on, in order to dynamically track one's geolocation. The geolocation data can be updated continuously, at five minute intervals, at ten minute intervals, at hourly intervals, or according to any other period and saved in a database.

In additional embodiments, records of passively-transmitted geolocation data associated with a consumer can be retrieved to supplement the location data provided by the transaction records of a consumer. For example, many mobile devices carried by consumers passively transmit geolocation, time and date information on a periodic basis, or upon initiating an action. Such passive transmissions can occur, for example, via Bluetooth, WiFi, RFID, IP Address, phone cookie, cell tower ping, or activation of a link on a cell phone application. Such information is routinely broadcast, and can be obtained without opt-in registration, once the particular mobile device generating such data is linked to the consumer.

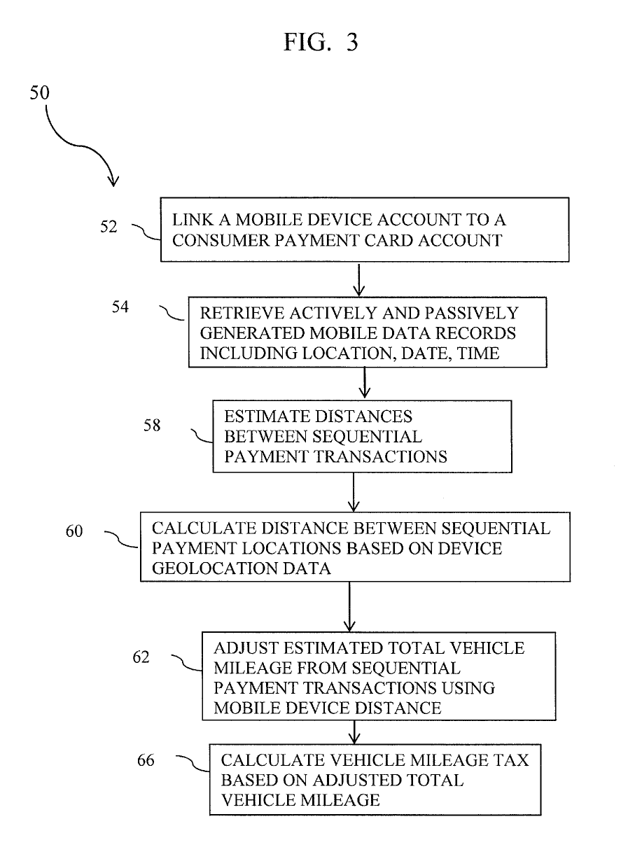

Accordingly, in particular embodiments, and with reference to FIG. 3, a mobile device that can provide geolocation and temporal data, actively and/or passively, is also linked to the consumer's payment card account 52, either by an opt-in registration program or by registrationless methods known in the art. Once the particular mobile device generating such data is linked to the consumer, additional records of geotemporal data associated with the consumer are retrieved 54 to supplement the location data provided by the payment transaction records of the consumer, and to adjust the estimate of total vehicle mileage determined from the payment transaction records.

For example, once a consumer's cell phone is linked to the payment account, records of ping data along with call detail records of calls made from the consumer's cell phone can be retrieved to supplement the location data provided by the transaction records of a consumer. The ping data and call data include geolocation data, along with a date and time stamp. For example, the ping data includes a User ID associated with the cell phone from which the ping originates, a geolocation, for example, a cell phone tower ID, which also corresponds to a georegion, or broadcast area, which is known to contain the user, and a timestamp (date and time) the ping data was generated. If a call is made, or GPS coordinates requested, more precise positional data will be stored in call detail records.

Accordingly, once a cell phone is also linked to the consumer, additional time-sequential geolocation data can be retrieved that corresponds to the cell phone location and used to verify or adjust the total vehicle mileage estimated from payment transaction records for a consumer over a predetermined period of time.

While such an integrated system of smartphone GPS and/or cell phone data, vehicle ownership, and payment data may be complex, it can be built immediately using existing infrastructure. In addition, there are no hardware installation requirements for consumer products. Accordingly, the system and method of the present disclosure could alternatively be used as a temporary implementation as government-mandated GPS installations are made to the millions of vehicles in the United States.

Referring again to FIG. 3, in another embodiment 50 for estimating a vehicle mileage tax of a vehicle associated with a consumer, a mobile device account, and associated geolocation, date and time data records are linked to the consumer payment account 52. For example, if the device is a cell phone, the mobile device records include both call detail and ping data records. The mobile device account can be linked either by matching the personal information identifier (PII) on telephone company and bank account records (if permitted and appropriate in accordance with privacy laws), by an opt-in registration process, or by other methods requiring no user registration.

One example of a registrationless linking of mobile device accounts to a consumer or consumer payment account is disclosed in co-owned U.S. Ser. No. 13/671,791, filed on Nov. 8, 2012 by Howe, which is entitled “Methods for Geotemporal Fingerprinting” (referred to herein as the “Geotemporal Fingerprinting” application), which is incorporated by reference herein in its entirety. The Geotemporal Fingerprinting application discloses a method and system for generating a geotemporal fingerprint from a database of users' activities, such as cell phone and/or other user social networking activity, and then using the fingerprint to link the user cell phone account to a consumer payment account. The Geotemporal Fingerprinting application also discloses correlating the raw ping and call data from a user's cell phone records directly to geolocation, time and date (geotemporal) data recorded in users' payment transaction records to link a consumer payment account to a cell phone account.

Another example of registrationless linking of a mobile device to a payment card account is disclosed in co-owned U.S. Ser. No. 13/920,920, filed on Jun. 18, 2013 by Howe, which is entitled “Geo-Enumerative Deviceholder Authentication” (referred to herein as the “Deviceholder” application), and which is incorporated by reference herein in its entirety. The Deviceholder application discloses a registrationless method of linking a registration ID associated with a mobile device to a payment card account.

Referring again to FIG. 3, once the mobile device is linked to the consumer payment account, the mobile device geotemporal records, both those actively and passively generated (such as the call and ping data records associated with a cell phone), can be retrieved 54 over any predetermined period of time and, if needed, are ordered in time sequential fashion for comparison and correlation to the payment transaction geotemporal data.

As also described in reference to FIG. 2 at block 34, initially, the distance or mileage traveled by the vehicle is estimated from the locations of sequential pairs of payment account transactions 58. Contemporaneous geolocation data retrieved from one or more mobile devices is then also retrieved and used to adjust the estimated vehicle mileage. In one embodiment, passively broadcast data, such as cell phone ping data is used, which is captured at periodic intervals. In other embodiments, the exact location of the consumer may be derived, both at the time of the payment transaction and during the interim period between payment transactions, from GPS tracking, WiFi location inference, Bluetooth, or other geolocating mechanisms provided by the mobile device.

Accordingly, in one embodiment, the method can also include calculating a distance between sequential payment locations based on contemporaneous mobile device geolocation data 60. Such data can be used to more accurately define the actual route taken by the consumer between locations associated with the payment account transactions 62, and to identify additional miles traveled in the interim. The vehicle mileage tax is then based on the adjusted total vehicle mileage 66 determined from a combination of the geotemporal data from both the mobile device and the payment transactions.

One concern in relying on mobile device and/or payment transaction data to calculate vehicle mileage is the possibility that some of the consumers' travels are via mass transit, and would not accurately reflect their vehicle mileage. Accordingly, in various additional embodiments, other adjustments to the estimated vehicle mileage are made to discount those miles attributed to mass transit.

For example, in various embodiments, consumers are identified from their payment transactions as purchasers of train tickets, bus fare, and other mass transit. The amount of the purchase is an excellent indicator of how often mass transportation is used (rarely, daily, etc.), and whether travel occurred by plane, train, bus, or car. In addition, such identifying information is often provided in the actual details of the payment transaction records.

On the other hand, confirmation of the actual miles traveled is provided by recording the amount of bridge and highway tolls paid. Of course, such payment transaction data is also extremely useful in refining mileage estimates between payment transactions, as well as in confirming the extent of travel geolocations (i.e., travel to different states compared to circuitous travel).

Vehicle mileage estimates can also be refined by adding up a cardholder's gas station purchase amounts, as correlated with mileage driven. While this is expected to vary based on the MPG of the vehicle driven, greater gas station spend will always be positively correlated with mileage driven.

Payment networks are already used in an overwhelming majority of fuel purchases, including, at automated fuel dispensers (“AFD”s), and may also similarly be used for payment of tolls, mass transportation purchases, and so on. Not only are the methods and systems described in the present disclosure helpful for identifying the miles driven, but they may also provide a means for automatic payment of a vehicle mileage tax at such locations.

Accordingly, in additional embodiments, a vehicle mileage tax accrued between two purchases of fuel can be calculated and collected with the latter purchase of fuel. Subsequent tax collections can be temporally spaced to coincide with any predetermined period of time, or can be triggered by sequential purchases of fuel, the miles taxed corresponding to those accrued in the interim between purchases.

In yet another embodiment, an estimated vehicle mileage of a test vehicle determined in accordance with any of the methods of the present disclosure is compared with the vehicle mileage determined from a GPS tracker, and/or odometer, installed in the vehicle for a statistical sample of vehicles. The data collected can then be used to more accurately estimate miles driven for representative drivers of differing areas of residence (city, suburb, country), for example, to enable auto-correction of the methods described herein.

System for Implementing the Methods of the Present Disclosure

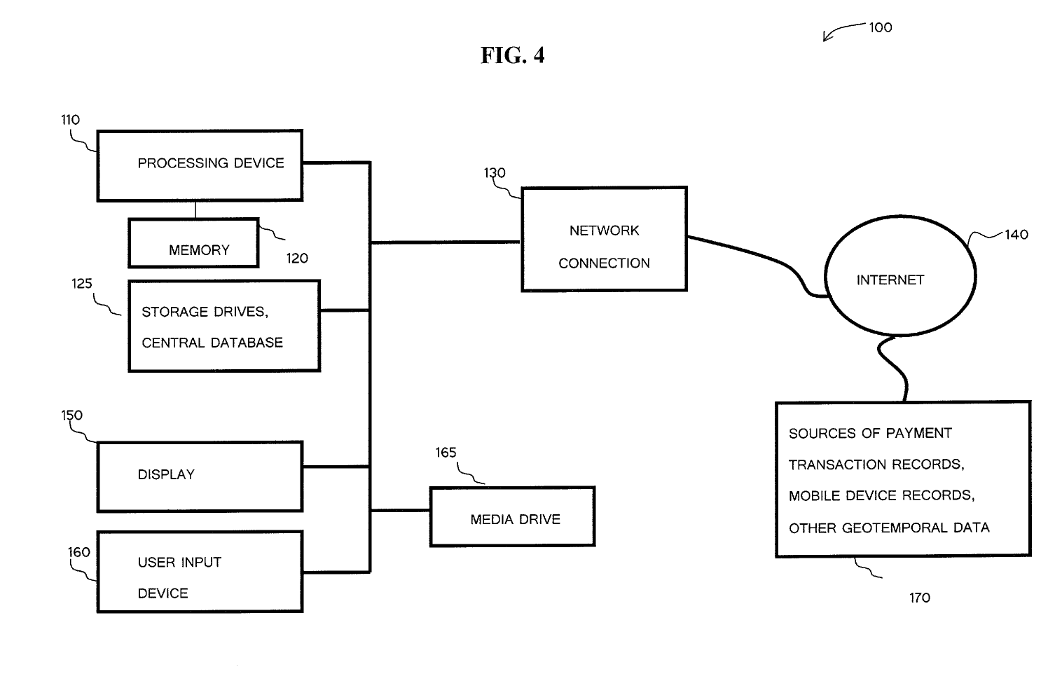

Referring to FIG. 4, the various embodiments of the methods of the present disclosure are implemented via computer software or executable instructions or code. FIG. 4 is a schematic representation of an embodiment of a system 100 for implementing the methods of the present disclosure. The system includes at least a processing device 110 including a Central Processing Unit (CPU), memory or computer readable storage 120, storage drives 125 preferably including a central database associated with the payment network, and a network connection 130 for connecting to sources of consumers' payment transaction records, mobile device records, and other sources of geotemporal data associated with consumers as described herein 170, via the Internet 140, for example, and for interacting with other systems and components of the payment card network.

The payment transaction data, mobile device records, and other geotemporal and consumer data are preferably stored in the central database.

Referring still to FIG. 4, the system 100 can be integrated with a computer workstation with display 150 and input keypad or keyboard 160. The memory or computer readable storage 120 is accessible by the CPU and stores instructions that when executed by the CPU 110 causes the processor 110 to implement the steps of the methods described herein. The memory 120 can include, but is not limited to, random access memory (RAM), read only memory (ROM), a storage device including a hard drive, or a portable, removable computer readable medium, such as a compact disk (CD) or a flash memory, or a combination thereof. The computer executable instructions for implementing the methods of the present invention may be stored in any one type of memory associated with the system 100, or distributed among various types of memory devices provided, and the necessary portions loaded into RAM, for example, upon execution.

In one embodiment, a non-transitory computer readable product is provided, which includes a computer readable medium that can be accessed by the CPU, via a media drive 165, for example, the computer readable medium storing computer executable instructions or program code for performing the method steps described herein. It should be recognized that the components illustrated in FIG. 4 are exemplary only, and that it is contemplated that the methods described herein may be implemented by various combinations of hardware, software, firmware, circuitry, and/or processors and associated memory, for example, as well as other components known to those of ordinary skill in the art.

While the methods and system of the present disclosure have been particularly shown and described with reference to specific embodiments, it should be apparent to those skilled in the art that the foregoing is illustrative only and not limiting, having been presented by way of example only. Various changes in form and detail may be made therein without departing from the spirit and scope of the disclosure. Therefore, numerous other embodiments are contemplated as falling within the scope of the present methods and system as defined by the accompanying claims and equivalents thereto.

What is claimed is:

1. A method of determining a vehicle mileage tax associated with a consumer, the method comprising:
retrieving, by a processing device, data associated with a plurality of transactions associated with a payment account of a consumer, the data including a merchant identifier, a location, and a date and time associated with each of the plurality of transactions;
estimating, by the processing device, a total mileage traveled by a vehicle associated with the consumer based on the location, and the date and time associated with the plurality of transactions; and
calculating, by the processing device, a vehicle mileage tax based on the total mileage estimated for the vehicle associated with the consumer.

2. The method of claim 1, further comprising calculating, by the processing device, a first distance between a pair of sequential locations associated with a time-sequential pair of the plurality of transactions, wherein the estimating the total mileage includes summing a plurality of distances associated with the consumer, the plurality of distances including the first distance.

3. The method of claim 1, wherein the plurality of transactions occur within a predetermined period of time, further comprising determining a total route distance corresponding to the plurality of transactions, wherein the total route distance is based on each distance between each pair of sequential locations associated with the plurality of transactions, wherein the total mileage includes the total route distance.

4. The method of claim 1, further comprising determining the vehicle mileage tax accrued at a point of sale location, the vehicle mileage tax accrued being associated with the payment account of a payment instrument presented by the consumer at the point of sale location, and wherein the vehicle mileage tax accrued is included on a bill of sale for payment by the consumer at the point of sale location.

5. The method of claim 1, further comprising linking, by the processing device, a mobile device associated with the consumer to the payment account, and recording, by the processing device, geotemporal data comprising location, date and time data associated with the mobile device, wherein the estimating the total mileage traveled by the vehicle is additionally based on the geotemporal data of the mobile device associated with the consumer.

6. The method of claim 5, wherein the mobile device is a cellular phone.

7. The method of claim 5, wherein both the plurality of transactions and the geotemporal ping data associated with the mobile device occur within a predetermined period of time.

8. The method of claim 3, further comprising generating a list of consumers who purchase tickets as users of mass transit, and adjusting the total route distance associated with the consumer for determining the vehicle mileage tax in response to identifying the consumer as one of the users of mass transit.

9. A system to determine a vehicle mileage tax associated with a consumer, the system comprising:
a processing device; and
a computer-readable storage medium storing instructions that, when executed by the processing device, cause the processing device to determine a vehicle mileage tax associated with a consumer by performing a computer process comprising:
retrieving data associated with a plurality of transactions associated with a payment account of a consumer, the data including a merchant identifier, a location, and a date and time associated with each of the plurality of transactions;
estimating a total mileage traveled by a vehicle associated with the consumer based on the location, and the date and time associated with the plurality of transactions; and
calculating a vehicle mileage tax based on the total mileage estimated for the vehicle associated with the consumer.

10. The system of claim 9, wherein the computer process further comprises calculating a first distance between a pair of sequential locations associated with a time-sequential pair of the plurality of transactions, wherein the estimating the total mileage includes summing a plurality of distances associated with the consumer, the plurality of distances including the first distance.

11. The system of claim 9, wherein the plurality of transactions occur within a predetermined period of time, and wherein the computer process further comprises determining a total route distance corresponding to the plurality of transactions, wherein the total route distance is based on each distance between each pair of sequential locations associated with the plurality of transactions, and wherein the total mileage includes the total route distance.

12. The system of claim 9, wherein the computer process further comprises determining the vehicle mileage tax accrued at a point of sale location, the vehicle mileage tax accrued being associated with the payment account of a payment instrument presented by the consumer at the point of sale location, and wherein the vehicle mileage tax accrued is included on a bill of sale for payment by the consumer at the point of sale location.

13. The system of claim 9, wherein the computer process further comprises linking a mobile device associated with the consumer to the payment account, and recording geotemporal data comprising location, date and time data associated with the mobile device, wherein the estimating the total mileage traveled by the vehicle is additionally based on the geotemporal data of the mobile device associated with the consumer.

14. The system of claim 11, wherein the computer process further comprises generating a list of consumers who purchase tickets as users of mass transit, and adjusting the total route distance associated with the consumer for determining the vehicle mileage tax in response to identifying the consumer as one of the users of mass transit.

15. The system of claim 13, wherein both the plurality of transactions and the geotemporal ping data associated with the mobile device occur within a predetermined period of time.
